(19) United States
(12) Patent Application Publication
(10) Pub. No.: US 2021/0339368 A1
(43) Pub. Date: Nov. 4, 2021

(54) QUICK REVERSE RETAINING RING PLIERS

(71) Applicant: JS Products, Inc., Las Vegas, NV (US)

(72) Inventor: Chungeng Chen, Las Vegas, NV (US)

(21) Appl. No.: 17/240,413

(22) Filed: Apr. 26, 2021

Related U.S. Application Data
(60) Provisional application No. 62/704,260, filed on Apr. 30, 2020.

(51) Int. Cl. B25B 27/20

(52) U.S. Cl. CPC B25B 27/205

(57) ABSTRACT

A tool, such as pliers, is configured to permit two modes or configurations of operation, such as for use in manipulating internal and external retaining rings. In one mode of operation, tool tips are moved towards one another when handles of the pliers are compressed towards one another, and in a second mode of operation, the tool tips are moved away from one another when the handles of the pliers are compressed towards one another. The modes of operation may be selected, such as by rotating a rotatable selector which controls connection of first and second handles of the pliers with first and second tool bodies.

### RELATED APPLICATION DATA

This application claims priority to U.S. Provisional Application Ser. No. 62/704,260, filed Apr. 30, 2020, and incorporate by reference said application as if set forth fully herein.

### FIELD OF THE INVENTION

The present invention relates to pliers.

### BACKGROUND OF THE INVENTION

Retaining rings are commonly used as retaining or locking members, such as to retain one or more elements on a shaft or similar circular or cylindrical-shaped body.

FIG. 10 illustrates an “external” retaining ring E. The external ring E comprises a body B which has a first end and a second end. The body B is generally circular in shape such that the first and second ends are located adjacent to one another (but not attached or connected). A tool aperture A may be provided at each end. In order to place the retaining ring on a shaft S or similar element, the ends must be biased away from one another, such as in the direction of the arrows illustrated in FIG. 10. This increases the inner dimension of the body B, thus allowing it to fit over or onto the shaft or other element, and whereby once placed, the biasing force of the retaining ring maintains the ring in position on the shaft or other element.

FIG. 11 illustrates an “internal” retaining ring I. The internal ring I again comprises a body B which has a first end and a second end. Once again, the body B is generally circular in shape, such that the first and second ends are located adjacent to one another (but not attached or connected). A tool aperture A may be provided at each end. In order to place the retaining ring inside of a body, such as in an aperture or opening thereof, the ends must be biased towards one another, such as in the direction of the arrows illustrated in FIG. 11. This reduces the outer dimension of the body B, permitting it to fit into the desired opening and whereby once placed, the biasing force of the retaining ring maintain the ring in position.

Conventionally, pliers or other tools may be used to bias the ends of the retaining rings towards or away from one another. Existing tools, such as pliers, for use in manipulating these retaining rings have a number of drawbacks. For example, pliers exist which have a pair of handles which are hinged, where each handle has a tool tip for engaging the aperture of a retaining ring. The user can place the tool tips into the apertures of a retaining ring and then manipulate the handles to manipulate the retaining ring. In the case of an internal ring, use of the pliers is simple: by gripping the handles and compressing them towards one another, the tool tips move towards one another, thus compressing the internal retaining ring. Manipulation of an external retaining ring is more problematic, however, as it requires the user to separately grip each handle of the pliers and trying to pull then handles apart, all while still keeping the tool tips engaged with the retaining ring. This can be very difficult, both in terms of generating sufficient force to open the retaining ring, to being able to locate the retaining ring on the shaft, to preventing the retaining ring from falling off of the tool.

An improved tool for use in manipulating retaining rings is desired.

### SUMMARY OF THE INVENTION

Aspects of the invention comprise a tool and methods of configuring and using the tool. In one embodiment, the tool is particularly suited for use in manipulating retaining rings, including both retaining rings of the external and internal varieties. In one embodiment, the tool comprises pliers, and most preferably pliers which can be reversed between first and second modes or configurations, including a first mode or configuration for use in manipulating external retaining rings, and a second mode or configuration for use in manipulating internal retaining rings.

One embodiment of the invention comprises pliers having a reversing mode of operation, comprising a first tool body having a first end and a second end and a tool tip at the first end, a second tool body having a first end and a second end and tool tip at the first end, the first and second tool bodies pivotally connected to one another, a first handle having a first end and a second end, a second handle having a first end and a second end, the first and second handles pivotally connected to one another, and means for selectively connecting the first handle to the second tool body and the second handle to the first tool body in a first mode of operation and the first handle to the first tool body and the second handle to the second tool body in a second mode of operation.

In one embodiment, the means for selectively connecting comprises a selector, such as a rotatable selector. The selector may be configured to selective engage on or more connectors, such as pins, that connect the first and second handles to the first and second tool bodies.

Another embodiment of the invention comprises pliers which comprise: a first tool body having a first end and a second end and a tool tip at the first end, a second tool body having a first end and a second end and tool tip at the first end, the first and second tool bodies pivotally connected to one another in a scissor configuration, the pivotal connection between the first and second ends of the first tool body and the first and second ends of the second tool body, a first handle having a first end and a second end, a second handle having a first end and a second end, the first and second handles pivotally connected to one another, a first pin associated with the first handle, the first pin movable from an unengaged position to an engaged position in which the first pin engages the first end of the first tool body, a second pin associated with the first handle, the second pin movable from an unengaged position to an engaged position in which the second pin engages the second end of the second tool body, a third pin associated with the second handle, the third pin movable from an unengaged position to an engaged position in which the third pin engages the first end of the first tool body, a fourth pin associated with the second handle, the fourth pin movable from an unengaged position to an engaged position in which the fourth pin engages the second end of the first tool body, wherein the pliers are configurable into a first mode of operation when the second and fourth pins are moved to their engaged position while the first and third pins remain in their unengaged position, whereby the first handle is connected to the second end of the second tool body and the second handle is connected to the second end of the first tool body, and wherein the pliers are configurable into a second mode of operation when the first and third pins are moved to their engaged position while the second and fourth pins remain in their unengaged position, whereby the first handle is connected to the first end of the first tool body and the second handle is connected to the first end of the second tool body.

Another embodiment of the invention comprises a method of using pliers comprising the steps of configuring pliers into a first mode of operation by moving a mode selector to a first position, compressing first and second handles of the pliers towards one another to effectuate movement of first and second tool tips of the pliers towards one another, configuring the pliers into a second mode of operation by moving the mode selector to a second position, and compressing the first and second handles towards one another to effectuate movement of the first and second tool tips away from one another.

Further objects, features, and advantages of the present invention over the prior art will become apparent from the detailed description of the drawings which follows, when considered with the attached figures.

### DESCRIPTION OF THE DRAWINGS

FIG. 1 is a top perspective view of a tool of the present invention;

FIG. 2 is a bottom perspective view of the tool illustrated in FIG. 1;

FIG. 3 is partial exploded view of the tool illustrated in FIG. 1;

FIG. 4 is a top view of the tool illustrated in FIG. 1;

FIG. 5 is a side view of the tool illustrated in FIG. 1;

FIG. 6 is a cross-sectional view of the tool illustrated in FIG. 4, taken along line 6-6 therein;

FIG. 7 is a cross-sectional view of the tool illustrated in FIG. 4, taken along line 7-7 therein;

FIG. 8 is an exploded view of the tool illustrated in FIG. 1;

FIG. 9 is a bottom view of a selector in accordance with an embodiment of the invention;

FIG. 10 illustrates operation of the tool illustrated in FIG. 1 in a first mode of operation; and

FIG. 11 illustrates operation of the tool illustrated in FIG. 1 in a second mode of operation.

### DETAILED DESCRIPTION OF THE INVENTION

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

One embodiment of the invention comprises a tool, and most preferably a tool which is particularly suited for use in manipulating retaining rings, including both retaining rings of the external and internal varieties. In one embodiment, the tool comprises pliers, and most preferably pliers which can be reversed between first and second modes or configurations, including a first mode or configuration for use in manipulating external retaining rings, and a second mode or configuration for use in manipulating internal retaining rings.

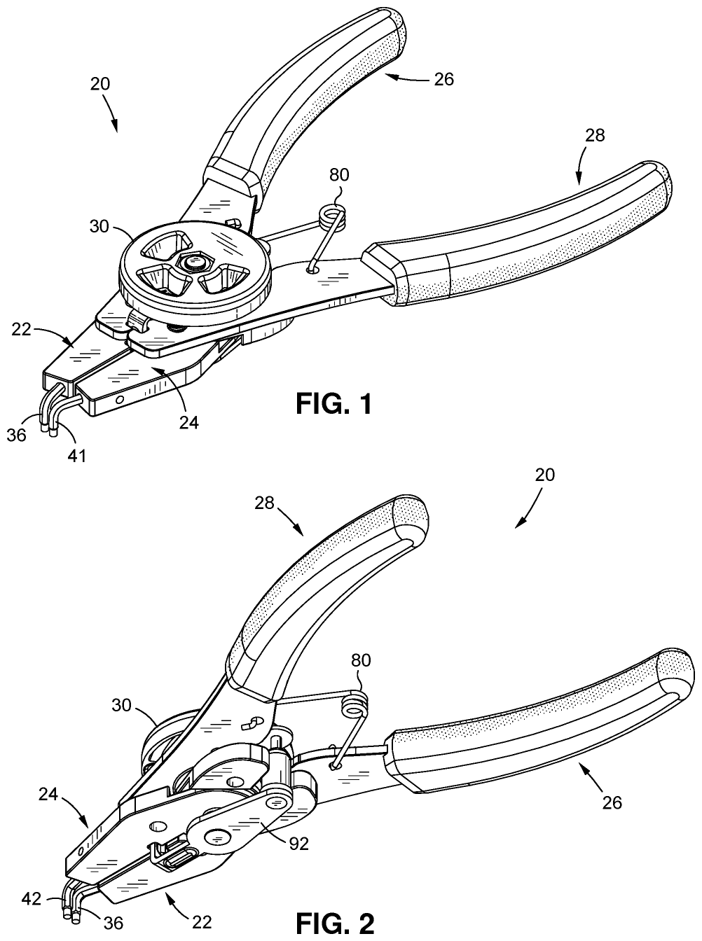

One embodiment of the invention will be described with reference to FIGS. 1-2. As illustrated therein a tool comprises pliers 20. The pliers 20 comprise a first tool body 22 and a second tool body 24, a first handle 26, a second handle 28, and means for selectively engaging the first and second handles 26,28 with the first and second tool bodies 22,24 in two modes or configurations. In one embodiment, as described in more detail, the means comprises a selector 30 for selectively engaging one or more connectors.

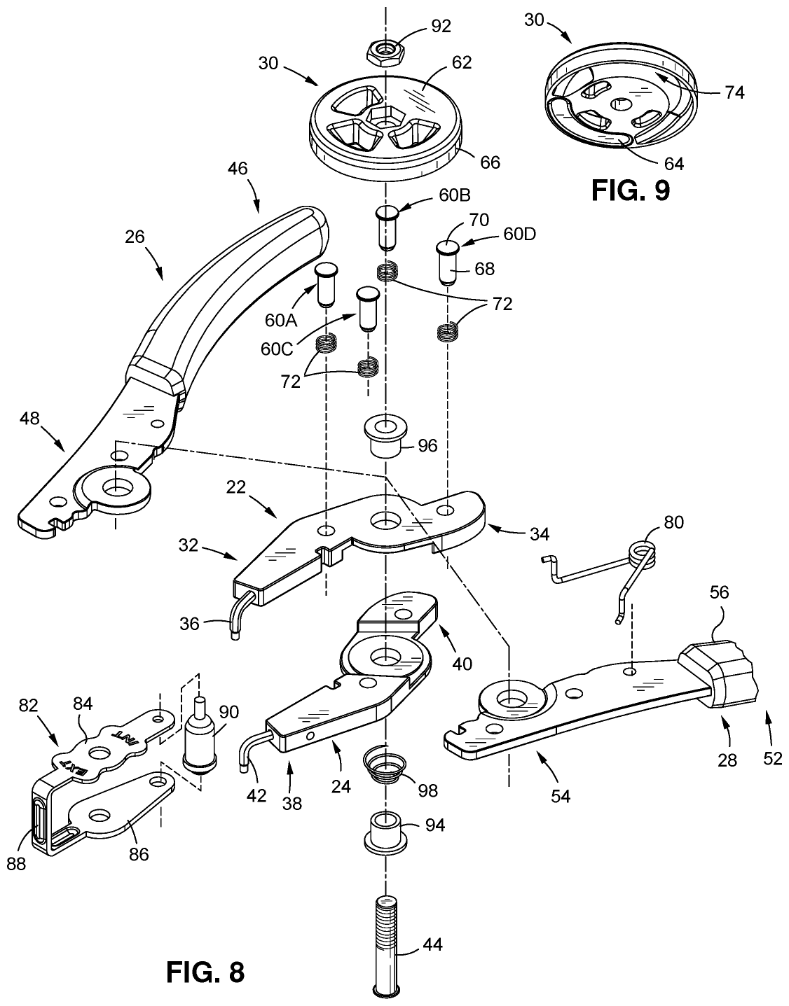

Referring primarily to FIG. 8, the first tool body 22 has a first end 32 and a second end 34. The first tool body 22 may have a first side, such as a top side, and an opposing side, such as a bottom side. In one embodiment, a retaining ring engaging member is associated with the first end 32. As also illustrated in FIGS. 1 and 2, this may comprise a generally “L”-shaped tip 36, such as where the tip 36 extends outwardly from the first end 32 and then bends towards the bottom side of the first tool body 22, such as at a generally 90 degree angle (e.g. thereby extending generally perpendicular to a plane containing the first tool body 22). The tip 36 is preferably configured to fit into the aperture of an end of a retaining ring.

The second tool body 24 has a first end 38 and a second end 40. The second tool body 24 may have a first side, such as a top side, and an opposing side, such as a bottom side. In one embodiment, a retaining ring engaging member is associated with the first end 38. As illustrated, this may again comprise a generally “L”-shaped tip 42, such as where the tip 42 extends outwardly from the first end 38 and then bends towards the bottom side of the second tool body 24, such as at a generally 90 degree angle (e.g. thereby extending generally perpendicular to a plane containing the first tool body 24). The tip 42 is again preferably configured to fit into the aperture of an end of a retaining ring.

The first and second tool bodies 22,24 are movably connected, such as by being pivotally connected. In one embodiment, a pin 44 extends through an aperture each of the first and second tool bodies 22,24. Preferably, the first tool body 22 is pivotally connected to the second tool body 24 between the first and second ends 32,34 of the first tool body 22 and the first and second ends 38,40 of the second tool body 24.

In the preferred configuration, the first and second tool bodies 22,24 are connected in a “scissor” fashion, where they cross one another (such that the first end 32 of the first tool body 22 and the second end 40 of the second tool body 24 are on one side of a longitudinal line through the pliers 20, and the second end 34 of the first tool body 22 and the first end 38 of the second tool body 24 are on the opposite side of that line).

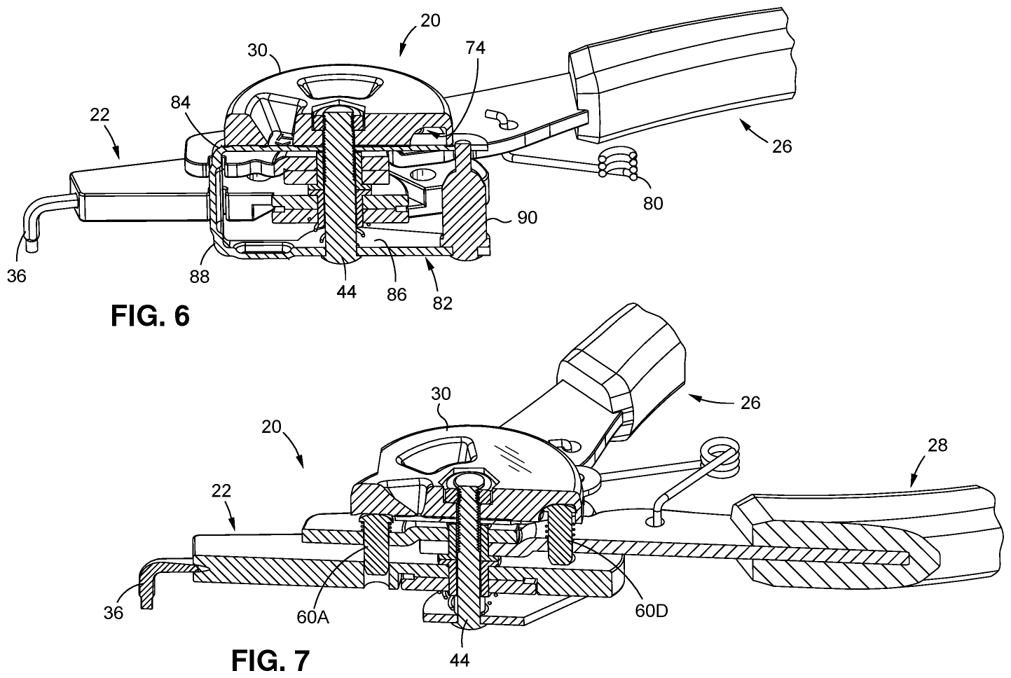

In one embodiment, as illustrated in FIGS. 6-8, so that the pliers 20 have a lower or thinner profile even though they overlap, the first tool body 22 may have an inset at its bottom side between its first and second ends 32,34 and the second tool body 24 may have an inset at its top side between its first and second ends 38,40. The insets may be about half of the thickness of the bodies 22,24, thereby causing the thickness of the pliers 20 at the area where the first and second tool bodies 22,24 pivotally overlap to be no greater than the rest of the tool bodies 22,24.

The first handle 26 has a first end 46 and a second end 48. The first handle 26 may have a first side, such as a top side, and an opposing side, such as a bottom side. In one embodiment, a grip 50 may be located on the first end 46 of the first handle 26. As described in more detail below, the second end 48 of the first handle 26 is configured to selectively engage the first tool body 22 (such as in one mode of operation) and the second tool body 24 (such as in another mode of operation).

The second handle 28 has a first end 52 and a second end 54. The second handle 28 may have a first side, such as a top side, and an opposing side, such as a bottom side. In one embodiment, a grip 52 may be located on the second end 54 of the second handle 28. As described in more detail below, the second end 54 of the second handle 28 is likewise configured to selectively engage the first tool body 22 (the one mode of operation) and the second tool body 24 (in another mode of operation).

The first and second handles 26,28 are also preferably mounted for movement relative to one another, such as by being pivotally mounted, and most preferably also mounted for pivotal movement relative to the first and second tool bodies 22,24. In one embodiment, the first handle 26 is pivotally mounted to the pin 44, between its first and second ends 46,48. Likewise, the second handle 28 is pivotally mounted to the pin 44, between its first and second ends 52,54. In one embodiment, the first and second handles 26, 28 are located at the top sides of the first and second tool bodies 22,24.

In one embodiment, so configured, the pliers 20 may have a distal end corresponding to the second ends 48,54 of the first and second handles 26,28, and a proximal end corresponding to the first ends 32,38 of the first and second tool bodies 22,24.

As indicated, the first and second handles 26,28 are configured to selectively engage the first and second tool bodies 22,24, such as to effectuate their movement in response to movement of the first and second handles 26,28.

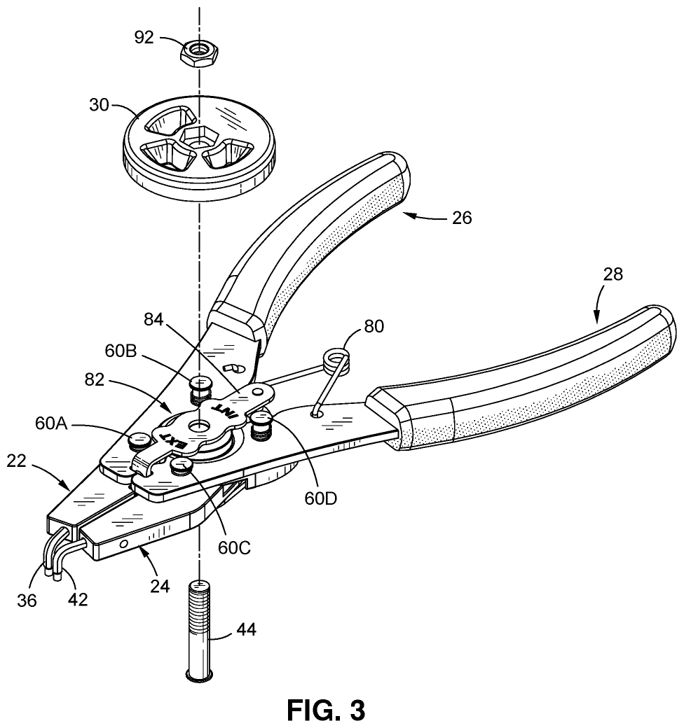

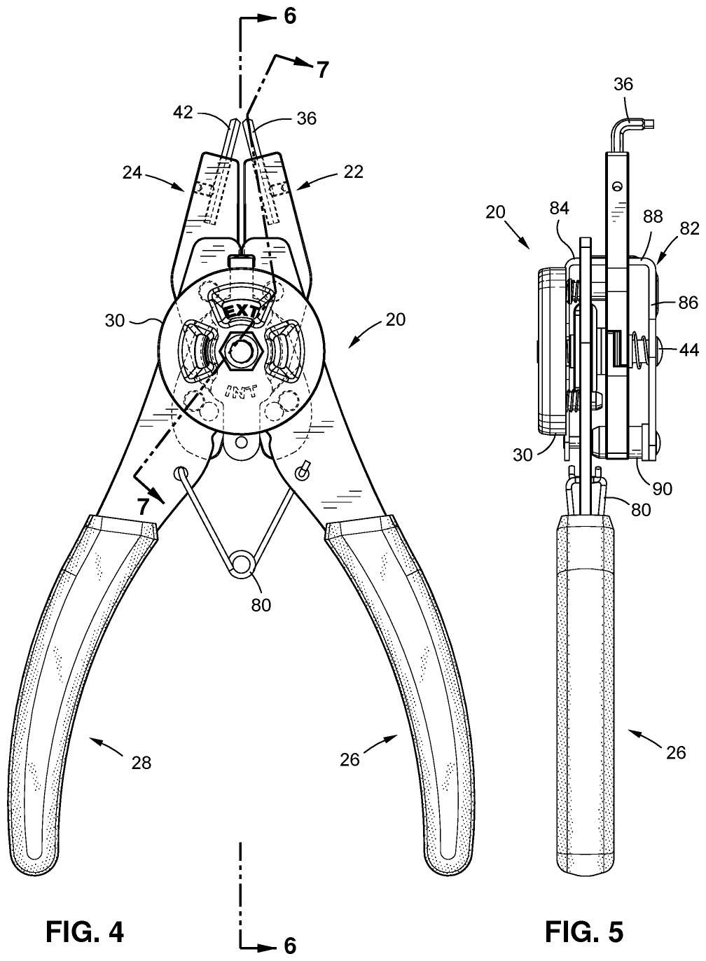

As illustrated in FIGS. 1-4 and 8, the selector 30 is located at the top side of the first and second handles 26,28. In one embodiment, the selector 30 is mounted for movement, such as to be moved between different positions so as to selectively control or engage one or more connectors. As described, the connectors may comprise pins 60.

As best illustrated in FIGS. 8-9, the selector 30 may comprise a generally cylindrical body which can be rotated. As such, the selector 30 is preferably pivotally mounted, such as by being mounted to the pin 44. In this embodiment, the selector 30 may have a top 62, an opposing bottom 64, and a peripheral edge 66. The bottom 64 may face the top of the first and second handles 26,28.

Still referring primarily to FIG. 8, the pins 60 are preferably associated with the first and second handles 26,28, and are configured to be selectively manipulated into engagement with the first and second tool bodies 22,24. In one embodiment, each pin 60 has a shank 68 with a head 70 at one end, and an opposing free end.

In one embodiment, four pins 60 are provided. A first pin 60A is associated with an aperture through the first handle 26 at its first end 46. A second pin 60B is associated with an aperture through the first handle 26 a location between the mounting of the first handle 26 to the pin 44 and the second end 48. A third pin 60A is associated with an aperture through the second handle 28 at its first end 52. A fourth pin 60D is associated with an aperture through the second handle 28 at a location between the mounting of the second handle 28 to the pin 44 and its second end 54. In one embodiment, each pin 60 is orientated so that the head 70 is positioned between the top of the first or second handle 26,28 and the bottom 64 of the selector 30, with the shank 68 of the pin 60 extending through its corresponding aperture in the handle 26,28. It is noted that while the head 70 of each pin 60 may be enlarged (compared to the shank), the pins 60 may have other configurations.

In one embodiment, a means is provided for biasing each pin 60 to a retracted or dis-engaged position. In one embodiment, this means may comprise a spring 72 which is positioned on the shank 68 between the head 70 and the first or second handle 26,28 with which the pin 60 is associated.

As described in more detail below, the selector 30 is configured to selectively engage the pins 60, such as to change their positions. In one embodiment, the bottom 64 of the selector 30 has a recess or inset 74 in a portion thereof, whereby the selector 30 can engage the pins 60 in a first position where they contact a first portion of the bottom 30 of the selector and whereby the selector 30 can engage the pins 60 in a second position where they contact the second, recessed portion 74 thereof. The recess or inset 74 may extend approximately 180 degrees around the bottom 64 of the selector 30 (whereby the first and second portions of the bottom 64 of the selector 30 are located approximately 180 degrees apart), and may have tapered or ramped portions comprising a transition between the recessed or inset portion and the non-recessed portion of the selector 30. As detailed below, when the first portion of the bottom 64 of the selector 30 engages the pins 60, those pins are pressed downwardly into engagement with the corresponding tool body 22,24, but when pins 60 are associated with the second, recessed portion 74 of the bottom 64 of the selector 30, the pins are not pressed downwardly into engagement with the corresponding tool body 22,24.

In one embodiment, the first pin 60A may selectively engage the first tool body 22, such as by extending into an aperture at the first end 32 thereof. The second pin 60B may selectively engage the second tool body 22, such as by extending into an aperture at the second end 40 thereof. Likewise, the third pin 60C may selectively engage the second tool body 24, such as by extending into an aperture at the first end 38 thereof, and the fourth pin 60D may selectively engage the first tool body 22, such as at the second end 34 thereof.

In one embodiment, second ends 48,54 of the first and second handles 26,28, may be biased away from one another. For example, a spring 80 may be positioned between the first and second handles 26,28 at a point distal of their mounting to the pin 44.

In one embodiment, the pliers 20 may comprise one or more alignment elements, such as a secondary mount 82. The secondary mount 82 may have a top strut 84 and a bottom strut 86 which are vertically offset, such as a via a support 88.

The support 88 may be located between the first end 32 of the first tool body 22 and the first end 38 of the second tool body 24. The top strut 84 may extend towards the distal end of the pliers 20, with the pin 44 passing there though, and where the top strut 84 is positioned between the top of the first and second handles 26,28 and the bottom 64 of the selector 30. The bottom strut 86 may extend towards the distal end of the pliers 30, with the pin 44 passing therethrough, and where the bottom strut 86 is positioned at the bottom side of the first and second tool bodies 22,24.

The first and second struts 84,86 may also be connected, such as at free ends thereof (generally opposite the support 88) such as by a connector, such as a pin 90. The pin 90 may be positioned between the second ends 34,40 of the first and second tool bodies 22,24 (towards the distal end of the pliers 20 from the pin 44).

In one embodiment, the pin 44 may have a shank with a head at one end and an opposing free end. At least a portion of the shank may be threaded. The pin 44 may be extended through the secondary mount 82, the first and second tool bodies 22,24 and the first and second handles 26,28, such as from the bottom side of the pliers 20. A nut 92 may be threaded into engagement with the free end of the pin 44, such as at the top 62 of the selector 30, thereby joining all of these elements. In one embodiment, the pin 44 may extend directly through these elements of the pliers 20, and in other embodiment, the pin 44 may extend through a first sleeve 94 and a second sleeve 96 (or one sleeve), where the first and second tool bodies 22,24 and/or first and second handles 26,28 are associated with the sleeves. Further, as illustrated, a spring 98 or other means for biasing may be provided between the pin 44 and the nut 92 (such as between the head of the pin 44 and the second tool body 24 for biasing the elements of the tool upwardly towards the nut 92).

Aspects of use and operation of the pliers 20 will now be described.

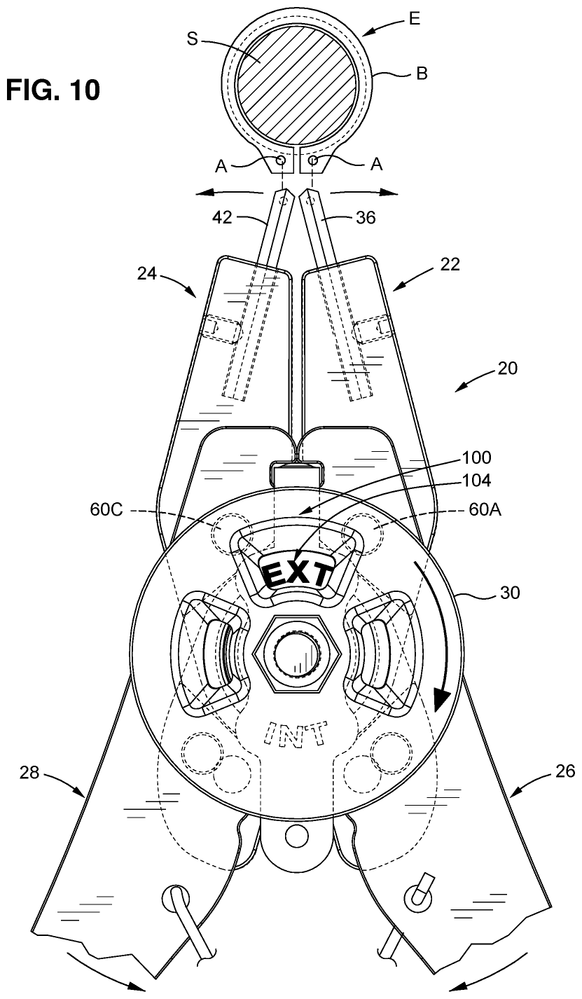

A user first selects a desired mode or configuration of operation of the pliers 20, such as illustrated in FIG. 10. A first mode or configuration is for use with external retaining rings. The user moves the selector 30 to a first position to select this mode. In one embodiment, means may be provided for indicating that the pliers 20 are in the first mode of operation. For example, as illustrated in FIG. 10, the selector 30 may define a window 100 therethrough. When the selector 30 is moved to a position corresponding to the first mode of operation, the window 100 may align with a first mode indicator 102, such as a label indicating “EXT” (or other indicator for “external” or other labelling), such as associated with the second mount 92).

In this position, the selector 30 pushes the first pin 60A (which is associated with the first handle 26) into engagement with the aperture at the first end 32 of the first tool body 22, and pushes the third pin 60C (which is associated with the second handle 28) into engagement with the aperture at the first end 38 of the second tool body 24. At the same time, the second pin 60B and fourth pin 60D are not engaged by the selector 30 (e.g., the springs 80 maintain those pins in a retracted position so that they don't engage the first and second tool bodies 22,24, with the heads of those pins 60B,60D located in the recess 74 in the bottom 64 of the selector 30).

The user engages the tips 36,42 of the pliers 20 with an external retaining ring, such as inserting the tips into the apertures in the ends of the external retaining ring. The user then squeezes the handles 26,28 towards one another at their second or gripping ends 48,54. This causes the first ends 32,38 of the first and second tool bodies 22,24 to move away from one another as the first and second tool bodies 22,24 pivot about the pin 44. The force applied by the user to the handles 26, 28 causes the ends of the external retaining ring to move away from one another, increasing the internal dimension of the external retaining ring, and thus allowing the user to place the external retaining ring over a shaft or other body.

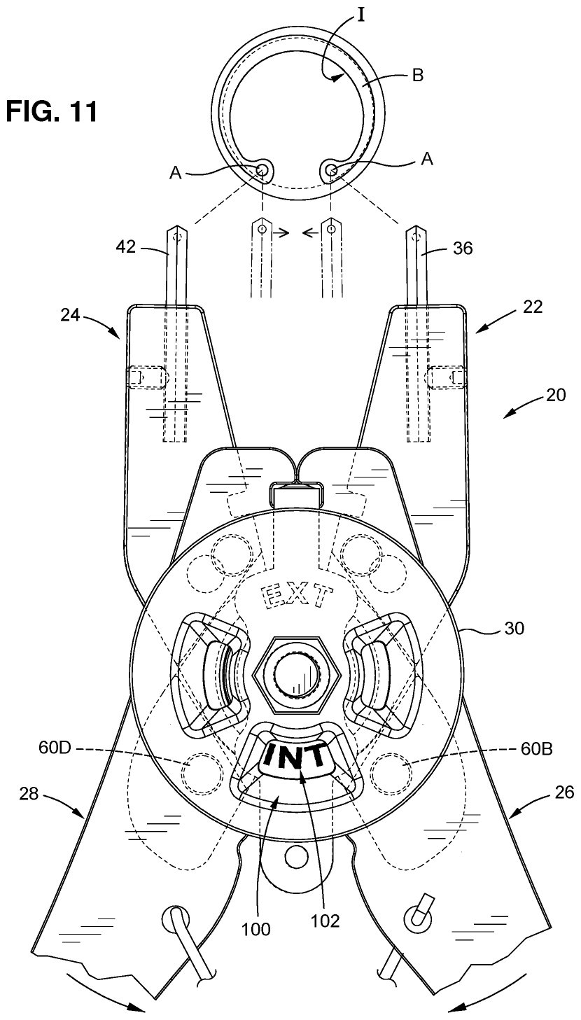

Most importantly, the pliers 20 permit a user to select a second mode or configuration of operation, as illustrated in FIG. 11. The second mode or configuration of operation is for internal retaining rings. The user moves the selector 30 to a second position to select this mode. This second position may be generally 180 degrees from the first position.

In one embodiment, means may be again provided for indicating that the pliers 20 are in the second mode of operation. For example, as illustrated in FIG. 11, when the selector 30 is moved to a position corresponding to the second mode of operation, the window 100 may align with a second mode indicator 102, such as a label indicating “INT” (or other indicator for “internal” or other labelling), such as associated with the second mount 92).

In the second position, the selector 30 pushes the second pin 60B (which is associated with the first handle 26) into engagement with the aperture at the second end 34 of the first tool body 22, and pushes the fourth pin 60D (which is associated with the second handle 28) into engagement with the aperture at the second end 40 of the second tool body 24), thus connecting the first handle 26 to the second tool body 24 and the second handle 29 to the first tool body 22. At the same time, the first pin 60A and third pin 60C are not engaged by the selector 30, as the heads 70 thereof are located in the recess 74 in the bottom 64 of the selector 30 (e.g., the springs 80 maintain those pins in a retracted position so that they don't engage the first and second tool bodies 22,24).

The user engages the tips 36,42 of the pliers 20 with an internal retaining ring, such as by inserting the tips into the apertures in the ends of the internal retaining ring. The user then squeezes the handles 26,28 towards one another at their second or gripping ends 48,54. This causes the first ends 32,38 of the first and second tool bodies 22,24 to move towards one another as the first and second tool bodies 22,24 pivot about the pin 44. The force applied by the user to the handles 26,28 causes the ends of the internal retaining ring to move towards one another, reducing the exterior dimension of the internal retaining ring, and thus allowing the user to place the internal retaining ring in a desired location.

Various aspect of the invention, including benefits thereof, will now be appreciated. Most importantly, the pliers 20 have first and second modes or configurations for use in manipulating internal and external retaining rings. In the preferred embodiment, in one mode of operation, the tool bodies or tips move in a first direction relative to one another (such as towards one another), and in a second mode of operation, the tool bodies or tips move in a second direction relative to one another (such as away from one another). Most preferably, the movement of the tool bodies or tips in completely different directions in the two modes of operation is effectuated even though in both instances, the user is moving the handles in the same manner—and preferably by squeezing the handles towards one another. Thus, the pliers 20 allow the user to cause the tool bodies or tips to move in different modes (and different relative directions) while the user simply squeezes the handles together in both modes of operation. This represents a significant advantage over tools of the prior art where the user is required to move the handles in different directions relative to one another in order to move the tool tips in different directions. This, for example, avoids the user having to try and force the handles apart from one another in certain modes of use.

Another advantage of the invention is the ability of the user to select the different modes of operation, such as by manipulation of a selector. As one aspect of the invention, the user does not need to manually connect the handles to the first and second tool bodies in different configurations. Instead, by merely turning or manipulating the selector, the connections of the handles to the tool bodies are modified.

The invention may have other configurations. For example, principles of the invention might be applied to other tools, such as pliers that have tool bodies or tips that have different configurations.

As indicated, in one embodiment, the pliers include a means for selection a mode or configuration of operation of the pliers (and more particularly, where the selection controls the connection of the handles to the first and second tool bodies into different configurations). As indicated, that selector may comprise a rotatable selector. However, other means might be utilized. For example, a toggle type selector might be utilized (which can be pressed, rotated or moved forwardly to engage the first and third pins 60A,60C but not the second and fourth pins 60B,60D or pressed, rotated or moved rearwardly to engage the second and fourth pins 60B,60D but not the first and third pins 60A,60C).

In another embodiment, the first pin 60A and third pin 60C might be located at the top of the pliers 20 and the second pin 60B and fourth pin 60D might be located at the bottom of the pliers. A push-button may extend over the pins at the top and bottom side of the pliers, where when the push-button is pressed down, it pushes the first and third pins 60A,60C into engagement, but causes the second and fourth pins 60B,60D to not be engaged (to be retracted), and vice versa.

Of course, in some embodiments, the means for selecting might be manual, such as where the user is required to engage each pin manually (for example, the pins could be threaded and the user could be require the turn the pins to that they screw into or out of engagement with the first and second tool bodies 22,24).

It will be understood that the above described arrangements of apparatus and the method there from are merely illustrative of applications of the principles of this invention and many other embodiments and modifications may be made without departing from the spirit and scope of the invention as defined in the claims.

What is claimed is:

1. A pliers having a reversing mode of operation, comprising:
a first tool body having a first end and a second end and a tool tip at the first end;
a second tool body having a first end and a second end and tool tip at the first end;
the first and second tool bodies pivotally connected to one another;
a first handle having a first end and a second end;
a second handle having a first end and a second end;
the first and second handles pivotally connected to one another; and
means for selectively connecting the first handle to the second tool body and the second handle to the first tool body in a first mode of operation and the first handle to the first tool body and the second handle to the second tool body in a second mode of operation.

2. The pliers in accordance with claim 1, wherein said means for selectively connecting comprises a selector.

3. The pliers in accordance with claim 2, wherein said selector is rotatable.

4. The pliers in accordance with claim 2, wherein said means for selectively connecting further comprises a plurality of pins.

5. The pliers in accordance with claim 3, wherein said plurality of pins comprises a first pin and a second pin associated with said first handle and a third pin and a fourth pin associated with said second handle.

6. The pliers in accordance with claim 4, wherein in a first position corresponding to said first mode of operation, said selector moves said second pin into engagement with said second tool body and said fourth pin into engagement with said first tool body, and wherein in a second position corresponding to a second mode of operation, said selector moves said first pin into engagement with said first tool body and said third pin in to engagement with said second tool body.

7. The pliers in accordance with claim 6, wherein said first, second, third and fourth pins are biased in an upward direction towards said selector and wherein in said first mode of operation said selector presses said second and fourth pins downwardly and in said second mode of operation said selector presses said first and third pins downwardly.

8. The pliers in accordance with claim 7, wherein said selector has a top and a bottom, the bottom having a first portion and a second portion which is recessed relative to said first portion, wherein in said first mode of operation, said first portion engages said second and fourth pins and said first and third pins are associated with said second, recessed portion thereof, and in said second mode of operation, said first portion engages said first and third pins and said second and fourth pins are associated with said second, recessed portion thereof.

9. The pliers in accordance with claim 1, wherein said first and second tool bodies are pivotally connected in a crossing-scissor style configuration.

10. Retaining ring pliers comprising:
a first tool body having a first end and a second end and a tool tip at the first end;
a second tool body having a first end and a second end and tool tip at the first end;
the first and second tool bodies pivotally connected to one another in a scissor configuration, said pivotal connection between said first and second ends of said first tool body and said first and second ends of said second tool body;
a first handle having a first end and a second end;
a second handle having a first end and a second end;
the first and second handles pivotally connected to one another;
a first pin associated with said first handle, said first pin movable from an unengaged position to an engaged position in which said first pin engages said first end of said first tool body;
a second pin associated with said first handle, said second pin movable from an unengaged position to an engaged position in which said second pin engages said second end of said second tool body;
a third pin associated with said second handle, said third pin movable from an unengaged position to an engaged position in which said third pin engages said first end of said first tool body;
a fourth pin associated with said second handle, said fourth pin movable from an unengaged position to an engaged position in which said fourth pin engages said second end of said first tool body;
wherein said pliers are configurable into a first mode of operation when said second and fourth pins are moved to their engaged position while said first and third pins remain in their unengaged position, whereby said first handle is connected to said second end of said second tool body and said second handle is connected to said second end of said first tool body, and wherein said pliers are configurable into a second mode of operation when said first and third pins are moved to their engaged position while said second and fourth pins remain in their unengaged position, whereby said first handle is connected to said first end of said first tool body and said second handle is connected to said first end of said second tool body.

11. The pliers in accordance with claim 10, wherein said tool tips are generally “L” shaped and have a portion configured to fit into a tool aperture of a retaining ring.

12. The pliers in accordance with claim 10, further comprising a mode selector.

13. The pliers in accordance with claim 12, wherein said mode selector is movable from a first position corresponding to said first mode of operation to a second position corresponding to said second mode of operation.

14. The pliers in accordance with claim 13, wherein said mode selector is rotatable from said first position to said second position.

15. The pliers in accordance with claim 10, wherein:
said first pin extends through a first aperture in said first handle, in said engaged position extends into an aperture in said first end of said first tool body, and is biased to said unengaged position in which said first pin does not extend into said aperture in said first end of said first tool body;
said second pin extends through a second aperture in said first handle, in said engaged position extends into an aperture in said second end of said second tool body, and is biased to said unengaged position in which said second pin does not extend into said aperture in second end of said second tool body;
said third pin extends through a first aperture in said second handle, in said engaged position extends into an aperture in said first end of said second tool body, and is biased to said unengaged position in which said third pin does not extend into said aperture in first end of said second tool body; and
said fourth pin extends through a second aperture in said second handle, in said engaged position extends into an aperture in said second end of said first tool body, and is biased to said unengaged position in which said fourth pin does not extend into said aperture in said second end of said first tool body.

16. The pliers in accordance with claim 15, wherein each of said pins is biased by a spring.

17. A method of using pliers comprising:
configuring pliers into a first mode of operation by moving a mode selector to a first position;
compressing first and second handles of said pliers towards one another to effectuate movement of first and second tool tips of said pliers towards one another;
configuring said pliers into a second mode of operation by moving said mode selector to a second position; and
compressing said first and second handles towards one another to effectuate movement of said first and second tool tips away from one another.

18. The method in accordance with claim 17, further comprising inserting said first and second tool tips into first and second apertures of an internal retaining ring before said step of compressing said first and second handles towards one another to effectuate movement of said first and second tool tips towards one another, and inserting said first and second tool tips into first and second apertures of an external retaining ring before said step of compressing said first and second handles towards one another to effectuate movement of said first and second tool tips away from one another.

19. The method in accordance with claim 17, wherein said steps of moving said mode selector comprises rotating said mode selector.
